(19) United States
(12) Patent Application Publication
(10) Pub. No.: US 2017/0272163 A1
(43) Pub. Date: Sep. 21, 2017

(54) COMPENSATION OF NONLINEAR IMPAIRMENT IN FIBER OPTIC LINKS BY INCLUDING DISTRIBUTED VARIATIONS OF WAVEGUIDE DISPERSIVE PROPERTIES

(71) Applicant: Nikola ALIC, La Jolla, CA (US)

(72) Inventor: Nikola ALIC, La Jolla, CA (US)

(21) Appl. No.: 15/460,542

(22) Filed: Mar. 16, 2017

Related U.S. Application Data
(60) Provisional application No. 62/309,501, filed on Mar. 17, 2016.

(51) Int. Cl. H04B 10/2543; H04J 14/02; H04B 10/61; H04B 10/2513

(52) U.S. Cl. CPC H04B 10/2543; H04B 10/25133; H04J 14/02; H04B 10/6161

(57) ABSTRACT

The invention relates to the aspects of implementation of compensation, or equalization devices aimed at nonlinear impairment mitigation in fiber optic communication systems by means of including the spatially varying dispersive characteristics, or parameters of the underlying waveguides and their potential performance improvement from utilization of those parameters.

### CROSS-REFERENCE TO RELATED APPLICATION

This application claims the benefit of U.S. Provisional Patent Application Ser. No. 62/309,501 by Nikola Alic, entitled “Compensation of Nonlinear Impairment in Fiber Optic Links by Including Distributed Variations of Waveguide Dispersive Properties,” and filed on Mar. 17, 2016, the contents of which are incorporated herein in their entirety by this reference.

### FIELD OF THE INVENTION

The present invention relates generally to fiber optic communication systems and in particular those systems that aim to have implemented mitigation of the nonlinear impairment, sometimes referred to nonlinear interaction, nonlinear crosstalk, or mixing.

### BACKGROUND OF THE INVENTION

Currently there are a number of solutions for mitigation of the nonlinear impairment in fiber optic communication systems. Some of these solutions attempt to reduce any nonlinear penalty by inverting the nonlinear impairment for a single channel only at a time, but these solutions fail to meet the needs of the industry because the resulting penalty from other interfering channels is much greater than the penalty of the single channel incurred onto itself. Other solutions attempt to apply some embodiment of phase conjugation at some point of the transmission link, but these solutions are similarly unable to meet the needs of the industry because transmission links are rarely ideally symmetric and/or constant as is necessary for the method of phase conjugation to be effective. Still other solutions seek to mitigate the nonlinear interaction in a multi-channel scenario by some implementation of the inverse propagation calculation assuming constant, or piece/span-wise constant link parameters, but these solutions also fail to meet industry needs because the latter assumption restricts the attainable level of the impairment mitigation, and thus limits the advantage, or improvement in the performance that can be obtained from these methods.

It would be desirable to have a composition that can attain the full theoretical possibility of nonlinearity mitigation, which/that can be used to increase the reach of these systems to more than 50% or 100% of the linear reach associated with systems in the absence of the nonlinear impairment mitigation techniques. Furthermore, it would also be desirable to have a composition that can attain tripling of the linear reach in these systems. Still further, it would be desirable to have a compound that can significantly increase the capacity of optical fiber-based transmission systems that do not employ nonlinear impairment mitigation techniques. Therefore, there currently exists a need in the industry for a composition that can improve operation and performance of nonlinear impairment mitigation techniques.

### SUMMARY OF THE INVENTION

The present invention advantageously fills the aforementioned deficiencies by providing compensation of nonlinear impairment in fiber optic links by taking into account the variations of waveguide dispersive properties along the transmission line, which thereby provides an improved system performance and allows a longer system attainable reach (in kilometers) and/or transmission of an increased overall information capacity or spectral efficiency.

The dispersive properties affect the relative velocities at which the information channels travel. Therefore, the evolution of the nonlinear interaction of transmitted signals is greatly influenced by the waveguide dispersive properties. As a consequence, significant improvements of the equalization performance are gained by including the distributed dispersive properties of the transmission line in the signal processing-based nonlinearity mitigation.

The present invention may also have one or more of the following properties: In one embodiment, the present invention can be used in the physical-model-based mitigation of the nonlinear impairment over the entire transmission line. Alternatively, the invention can be applied in only a part of the transmission line. The distributed variation of the dispersive properties can be obtained from direct or indirect transmission line properties, or by appropriate numerical optimization procedures. In yet another embodiment, the distributed dispersive properties can be obtained as a difference of the system response to the constant and un-changing system properties, even without and explicit access to the actual spatial variation of those properties. In taking advantage of non-constant transmission line dispersive properties, the assumed dispersive profiles can be continuously varying, piece-wise constant, a combination thereof, or obtained by some method of interpolation between a number of points in the transmission line with known, measured, or assumed dispersive properties—all along the line, or only parts thereof. The distributed and varying transmission line properties can be used in conjunction with a single wavelength-division multiplexing (WDM) channel, multiple channels, or all channels in the transmission system. The invention can be used in conjunction with nonlinear impairment mitigation based on free-running, frequency-referenced transmission system, or a combination thereof. The invention can be used in transmission lines based on single mode fibers, multimode fibers, multi-core fibers or a combination thereof. The application of the method can assume constant (i.e. time-invariant), or time varying distributed transmission line dispersive properties, for the entire transmission line, or any of its parts, a subset of which could be alternating (changing). The updates to the distributed dispersive properties, if available, can be made in regular, or irregular time intervals, or in accordance with system performance monitoring subsystem heuristic. The inclusion of the varying distributed dispersion characteristics can be used intermittently, or on regular basis in the system (i.e. with any of the possible embodiments mentioned above). The invention can be applied to nonlinear impairment mitigation techniques applied at the transmitter side of the transmission system (i.e. pre-compensation), receiver side (post-compensation), or a combination thereof; in the latter case the distributed variations of dispersive properties can be assumed at either one, or both sides of the system. The invention can be applied to nonlinearity mitigation method relying on some embodiment of phase conjugation, or the so-called twin-beam phase conjugated beams. The invention can be applied to nonlinearity mitigation systems relying on a combination of phase conjugation and digital (back-propagation) techniques. In yet another embodiment, the invention can be used as providing a correction (and thereby an improved performance) to other NLC methods assuming constant dispersive properties, including, but not limited to methods based on phase conjugation. The invention is applicable to transmission lines based on a single variety of the optical fiber, or different fiber types, including possible lumped, or distributed in-line elements with particular dispersive properties (which may or may not be included in the nonlinearity mitigation methods).

In a further embodiment, the invention can be applied in fibers having more than one core (the so-called multi-core fibers), and be used for compensation of nonlinear impairment within each of the cores separately, or taking into account the linear and nonlinear coupling of the cores. In yet another embodiment the invention can be used in fibers supporting more than a single transversal electro-magnetic mode.

The present invention method is unique when compared with other known processes and solutions in that it assumes inclusion and/or utilization of spatial variation of dispersive properties in the mitigation of the nonlinear impairment, which, in turn, allows attainment of an improved level of mitigation of the impairment, and thus an improved performance of these transmission systems.

The present invention is unique in that it is different from other known processes or solutions. More specifically, the present invention owes its uniqueness to the fact that it: (1) assumes structure of the nonlinear impairment mitigation implementation that is different from the state of the art implementations. Specifically, the implementation allows for distributed variations of the dispersive parameters and the respective change on both the system response and the signal processing technique implementation. (2) In the implementation, either explicitly, or implicitly the dispersive properties are treated as varying along the transmission line/system, according to spatial dispersion profiles that are either obtained from measurements, or are implicitly arrived at from the system response, in turn obtainable from the assumption of constant and unchanging relevant system parameters.

Among other things, it is an object of the present invention to provide a superior mitigation of the nonlinear impairment in fiber optic transmission systems that does not suffer from any of the problems or deficiencies associated with prior solutions.

It is still further an object of the present invention to allow for a longer reach of systems that may, or may not include some mitigation of the nonlinear impairment, with the latter relying on purely constant, or span-wise constant transmission line characteristics.

Further still, it is an object of the present invention to allow transmission of elevated information capacities, or spectral efficiencies, not attainable in the absence of the regard to the effect of spatially varying parameters of the transmission system.

One aspect of the present invention is a method for compensating for nonlinear impairment in single mode fiber optic communication systems comprising applying distributed, longitudinal variation of chromatic dispersion parameters having a longitudinal resolution smaller than the shortest span length in the link to compensate for nonlinear impairment. In one alternative, the method for compensating is implemented as a correction to span-wise constant compensation of nonlinear impairment in one or more spans in a transmission line operating by single mode fiber optic communication. In another alternative, the method for compensating takes into account longitudinal dispersion fluctuations on a subset of spans of a link. In yet another alternative, longitudinal variations of chromatic dispersions are implemented as piecewise constant functions along one or more spans of the transmission line. In still another alternative, the dispersion profile in one or more spans is obtained by interpolation of a spatially coarse dispersion profile. In still another alternative, a smoothed spatially varying profile is employed.

The method described above can employ pre-compensation, post-compensation, or a combination of pre-compensation and post-compensation. The compensating can be analog or digital.

Another aspect of the invention is a method for compensating for nonlinear impairment in multi-core fiber optic communication systems comprising taking into account distributed longitudinal variations of the chromatic dispersion in links including one or more multi-core fibers.

In this aspect of the invention, in one alternative, compensating is implemented as a correction to span-wise constant compensation of nonlinear impairment in one or more spans in the transmission line. In another alternative, compensating is implemented by taking into account longitudinal dispersion fluctuations on a subset of spans of a link. In one alternative, longitudinal variations of chromatic dispersions are implemented as piecewise constant functions along one or more spans of the transmission line. In yet another alternative, the dispersion profile in one or more spans is obtained with the inclusion of a type of interpolation selected from the group consisting of polynomial interpolation, spline interpolation, and another type of interpolation of a spatially-coarse dispersion profile. In still another alternative, smoothing of a spatially varying profile is employed.

The method described above can employ pre-compensation, post-compensation, or a combination of pre-compensation and post-compensation. The compensating can be analog or digital.

Another aspect of the present invention is a system for nonlinearity compensation employing pre-compensation comprising:

(1) a frequency-referenced bank of optical carriers;

(2) a first demultiplexer to which output from the frequency-referenced bank of optical carriers of (1) is conveyed;

(3) a multiplicity of transmitters to which output from the demultiplexer of (2) is conveyed;

(4) a nonlinearity compensation (NLC) computation engine;

(5) a transmission line comprising: (i) spans of optical fiber and (ii) optical amplifiers having first and second ends with the second end being a receiving end;

(6) a second demultiplexer to demultiplex WDM channels from the transmission line; and

(7) a plurality of receivers to detect signals produced by the second demultiplexer;

wherein the inverse of nonlinear interaction for particular data patterns to be transmitted over respective wavelength-division multiplexing (WDM) channels is computed in the NLC computation engine;
wherein the computed pre-compensating waveforms are imprinted onto the reference carriers in the respective transmitters;
wherein the computed pre-compensating waveforms are subsequently multiplexed by a WDM multiplexer and launched into the transmission line; and
wherein, at the receiving end, the WDM channels are de-multiplexed and are detected by the respective receivers.

In this system, the frequency-referenced bank of optical carriers can be derived from a frequency comb.

Yet another aspect of the present invention is a system for nonlinearity compensation employing post-compensation comprising:

(1) a set of transmitters;

(2) a plurality of WDM channels onto which information is imprinted by the set of transmitters of (1);

(3) a WDM multiplexer to multiplex the information from the plurality of WDM channels;

(4) a transmission line comprising: (i) spans of optical fiber and (ii) optical amplifiers having first and second ends with the second end being a receiving end;

(5) a first demultiplexer to demultiplex the WDM channels from the transmission line;

(6) a plurality of receivers to detect the demultiplexed WDM channels; wherein the receivers utilize a set of frequency referenced carriers as their local oscillators;

(7) a second demultiplexer to separate output from the local oscillators of (6); and

(8) a computational engine to perform nonlinearity mitigation based on received waveforms from the frequency referenced receiver bank.

In this system, the frequency-referenced bank of optical carriers can be derived from a frequency comb.

### BRIEF DESCRIPTION OF THE DRAWINGS

These and other features, aspects, and advantages of the present invention will become better understood with reference to the following description, appended claims, and accompanying drawings where:

FIG. 1 shows an approximate typical fiber loss dependence on wavelength with the windows with minimum loss being used in commercial systems for information transmission.

FIG. 2 shows a typical schematic of a wavelength division multiplex (WDM) system.

FIG. 3 shows a schematic of a wavelength division multiple system with pre-compensation of nonlinear impairment.

FIG. 4 shows a schematic of a wavelength division multiplex system with post-compensation of nonlinear impairment.

FIG. 5 shows a schematic of a nonlinearity compensation with fixed parameters.

FIG. 6 shows a schematic of a nonlinearity compensation including the longitudinal variation of dispersive parameters.

FIG. 7 shows a comparison between spatially varying and constant dispersion profiles.

### DETAILED DESCRIPTION OF THE INVENTION

The present invention is directed to compensation of nonlinear impairment in fiber optic links by including longitudinal variations of waveguide dispersive properties.

The major portion of the information transmission is conveyed by the fiber optic communication systems. These systems are implemented in the wavelength division multiplex (WDM) configuration, essentially consisting of a multitude of information channels, each with its particular central wavelength (or frequency), thus occupying the totality, or a portion of the available optical fiber bandwidth, most often occupying a window of a minimum loss of optical fibers located around the 1550 nm wavelength. In these systems a single-mode optical fiber is used as the transmission medium and derives its name from the fact that it supports a single transversal mode of electromagnetic radiation per polarization (and actually a total of two polarization modes, since light naturally admits two orthogonal polarizations). Incidentally, a major research development is currently focused on the so-called spatial division multiplexing systems which rely on either on fibers with more than one core, wherein each core can support single or multiple transversal modes. The fiber medium, itself, is associated with a number of impairments affecting the signals in propagation. In addition to the linear impairments such as chromatic dispersion, or polarization mode dispersion, the waveguide medium is characterized by the nonlinear response of its index of refraction which facilitates a partial transfer of information (often referred to as the nonlinear crosstalk) among the transmitted information channels, or otherwise a degradation of the integrity of the transmitted information even in the case of a single isolated channel. The particular characteristic of the described nonlinear impairment is its marked dependence on the transmitted channel power and the relative degradation augmentation with the increase of the transmitted channels' power. The described nonlinear effect upon the transmitted channels acts so as to impose a stringent limitation on the maximal signal power that can be launched prior to significant signal degradation, ultimately leading to a limitation in reach and capacity in these systems. Nonlinear compensation (NLC) techniques have been devised to counter, mitigate, or straight out cancel the nonlinear impairment in WDM systems. Generally speaking, the mitigation techniques rely on the fact that the nonlinear interaction among the WDM channels is deterministic, and provided the knowledge of the physical characteristics of the transmission system to a certain degree is available, this interaction can be reversed, or partially compensated, thus allowing an improved performance, reach and higher capacity in fiber optic transmission systems. In general terms, the methods for NLC can be analog (i.e. relying on the physical effects, constructs or laws to reverse in part, or in full the nonlinear impairment), or digital (i.e. utilize digital signal processing to compensate, or preempt the incurred nonlinear penalty). Regardless of the approach, the NLC methods rely on the particular knowledge of the physical characteristics of the transmission line which consists of spans of optical fiber with inline, or distributed optical amplifiers, which aliment the signal power in propagation over the transmission system. Of all of the physical characteristics of the transmission line, dispersive characteristics play the crucial role on the evolution of the nonlinear interaction which is distributed in nature (i.e. it occurs continually along the whole of the transmission system and accumulates in propagation). Generally, the fiber properties in the mitigation techniques are assumed as constant per fiber span. While demonstrably proven useful for nonlinearity mitigation these methods are inherently incapable of extracting the full nonlinearity mitigation. The reason for this is that the dispersive properties of a fiber span are innately changing along the spans of the transmission line. Therefore, to extract the full capability of NLC, regardless of the its particular implementation, the consideration of these spatially varying dispersive characteristics having kilometer scale resolution is critical and is the central part of this invention. In the preferred embodiment of this invention, the NLC is implemented by means of digital back-propagation (DBP). In this approach, the nonlinear interaction among channels is mitigated by inverting, or inversing the nonlinear interaction by means of computation of the incurred nonlinear interaction, which can be thought of as inter-mixing of the transmitted information channels. In DBP this reversal is obtained by relying on a computational engine that is essentially stepping backwards through the physical transmission system (thus undoing the incurred nonlinear penalty). As previously noted, the critical factor in the successful back-propagation method is the deterministic nature of this interaction. In calculation of the inverse the fiber characteristics are often assumed constant along each of the spans of the transmission line. The innovation which yields significant benefits consists of including the distributed varying properties in the NLC method, and specifically dispersive transmission line variations along the transmission line. The included distributed characteristics of the dispersive line can be obtained from physical measurement, or alternatively, by probing the transmission by specifically designed signals. Furthermore, the time variation of the distributed dispersion properties can also be implemented, taking into account the change of dispersive properties over time. Most importantly, the performance of the NLC, regardless of the complexity of the underlying implementation, can be improved by the inclusion of the distributed variation of the dispersive properties.

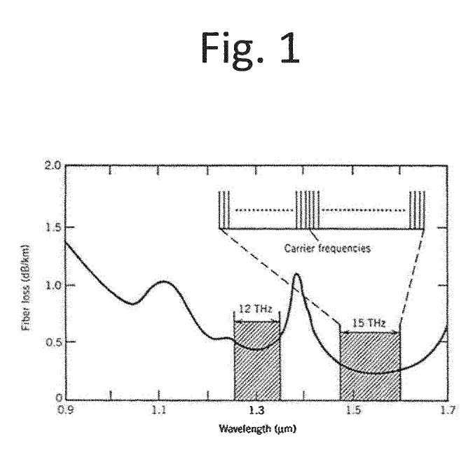

Referring to the figures, FIG. 1 shows the typical loss profile with respect to wavelength of a modern optical fiber. Modern wavelength division multiplex (WDM) transmission systems are implemented in the shaded band in the figure around the point of the minimum loss at 1.55 μm, dividing this band in a desired number of channels and allocating carriers for each of the channels.

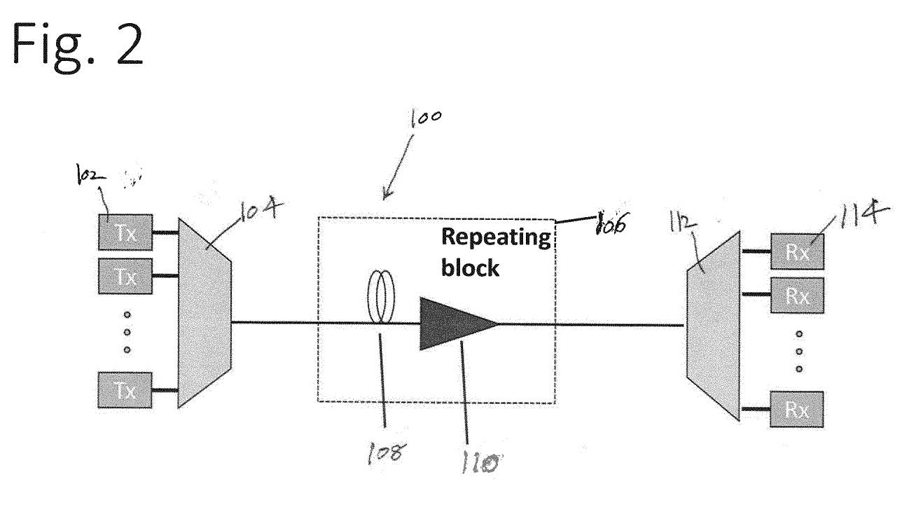

FIG. 2 shows a typical schematic of a WDM link 100 consisting of a set of transmitters 102 that are coupled together (or multiplexed) by a multiplexer 104 only to be launched into a transmission line 106 consisting of a optical fiber spans 108 and optical amplifiers 110. The fiber spans 108 are often, but not always of equal length. At the end of the link, the WDM channels are demultiplexed by a demultiplexer 112 and each of the channels is received by a dedicated receiver 114.

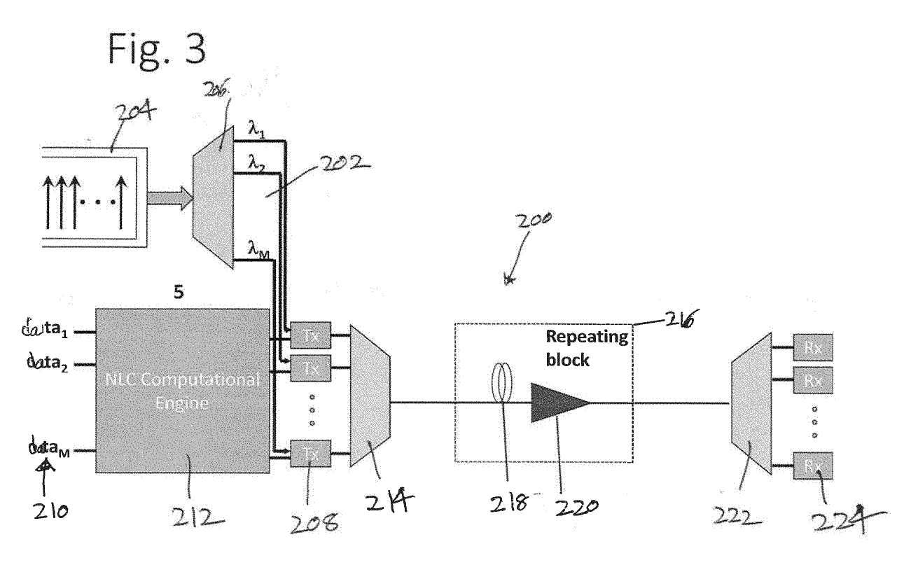

FIG. 3 shows an implementation of a WDM link 200 with nonlinearity cancellation (NLC) implemented as pre-compensation. The NLC utilizes a frequency-referenced bank of optical carriers 202, in this instance derived from a frequency comb 204, which, in turn, are conveyed by one demultiplexer 206 to the respective transmitters 208; in NLC the inverse of the nonlinear interaction for the particular data patterns 210 to be transmitted over the respective WDM channels is computed in the NLC computational engine 212. The computed pre-compensating waveforms are imprinted onto the reference carriers in the respective transmitters 208, which are subsequently multiplexed by a WDM multiplexer 214 and launched into the transmission line 216 consisting of spans of optical fiber 218 and optical amplifiers 220. At the receiving end the WDM channels are de-multiplexed by a de-multiplexer 222 and are detected by the respective receivers 224.

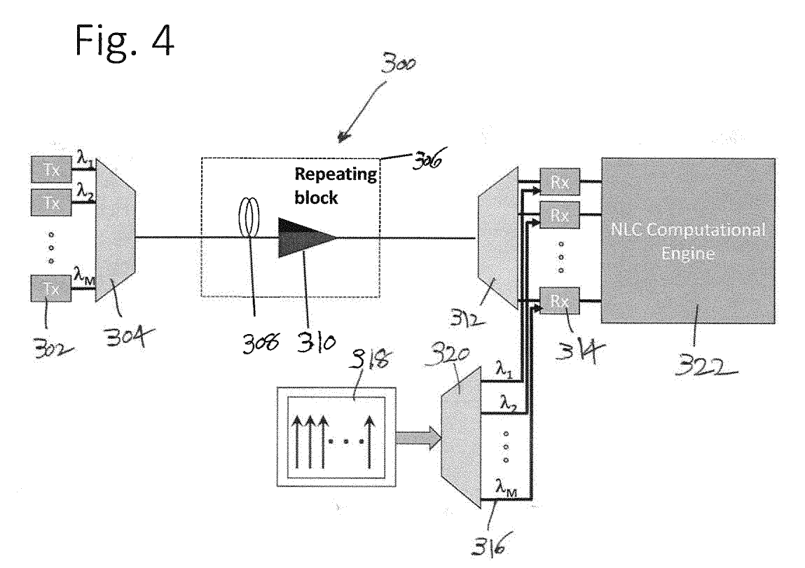

FIG. 4 shows an implementation of a WDM link with nonlinearity cancellation 300 implemented as post-compensation, with NLC being performed at the receiver. The information is imprinted onto the WDM channels by means of a set of transmitters 302, which are subsequently multiplexed by a WDM multiplexer 304 and launched into the transmission line 306 consisting of spans of optical fiber 308 and optical amplifiers 310. At the receiving end the WDM channels are de-multiplexed by a demultiplexer 312 and are detected by the respective receivers 314. The receivers utilized a set of frequency referenced carriers 316 as their local oscillators, which are, in this example drawn from a frequency comb 318 and are separated (demultiplexed) by another demultiplexer 320. Finally, the process of nonlinearity mitigation is performed by a computational engine 322 based on the received waveforms from the frequency referenced receiver bank.

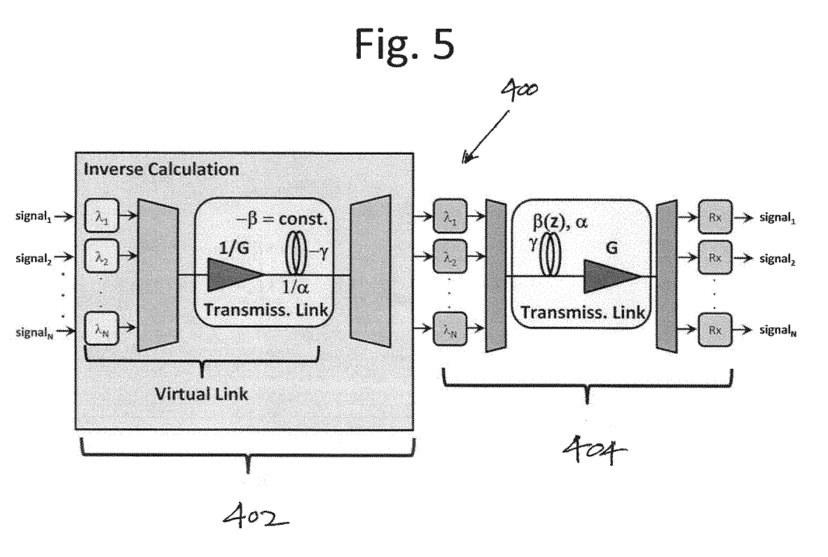

FIG. 5 shows a traditional NLC configuration 400. The inverse calculation is performed in the inverse-calculation computational block 402, based on the known, or estimated parameters of the physical transmission line. The physical line 404) has inherently non-constant dispersion parameters, as expressed by the β(z) dependence in the physical link block. However, the inverse calculation is performed assuming either constant, or span-wise-constant dispersion parameter β, or D, (note β=const. in the virtual link block diagram).

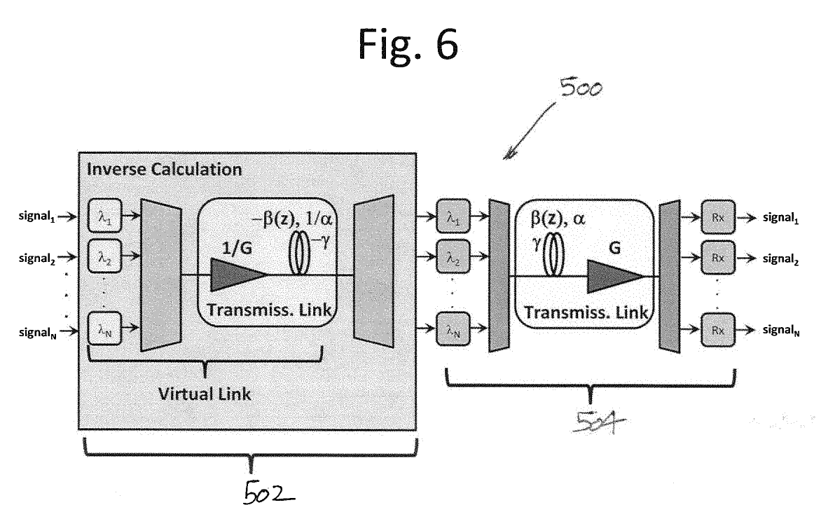

FIG. 6 shows a NLC configuration including dispersive variations 500. The inverse calculation is performed in the inverse-calculation computational block 502, based on the estimated or measured parameters of the physical transmission line. The physical line 504 has inherently non-constant dispersion parameters, as expressed by the β(z) dependence in the physical link block. In the implementation including the disclosed invention, the inverse calculation is performed including the measured, or otherwise indirectly estimated dispersion parameter β(z), or D(z), (note β(z) in the virtual link block diagram, implying the longitudinal, or distributed change of the fiber dispersion parameter), whereas the longitudinal resolution is smaller than the shortest span of the link.

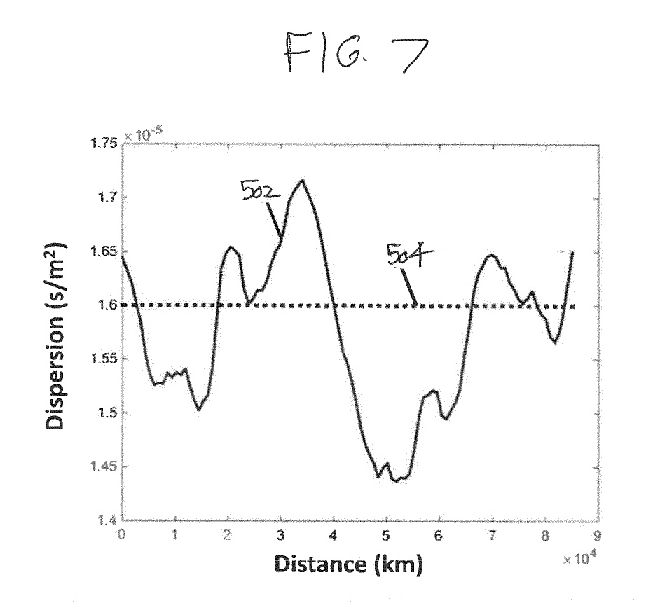

FIG. 7 shows a comparison between spatially varying and constant dispersion profiles. Specifically, FIG. 7 shows an example of a longitudinally varying dispersion profile 502 in an 85 km span, compared to a uniform dispersion profile 504. The latter is effectively a mean value of the profile 502. Note that a typical fiber optic transmission link consists of a multitude of spans whose length typically varies from 50 km to 120 km, or even longer.

Accordingly, one aspect of the present invention is a method for compensating for nonlinear impairment in single mode fiber optic communication systems comprising applying distributed, longitudinal variation of chromatic dispersion parameters having a longitudinal resolution smaller than the shortest span length in the link to compensate for nonlinear impairment. In one alternative, the method for compensating is implemented as a correction to span-wise constant compensation of nonlinear impairment in one or more spans in a transmission line operating by single mode fiber optic communication. In another alternative, the method for compensating takes into account longitudinal dispersion fluctuations on a subset of spans of a link. In yet another alternative, longitudinal variations of chromatic dispersions are implemented as piecewise constant functions along one or more spans of the transmission line. In still another alternative, the dispersion profile in one or more spans is obtained by interpolation of a spatially coarse dispersion profile. In still another alternative, a smoothed spatially varying profile is employed.

The method described above can employ pre-compensation, post-compensation, or a combination of pre-compensation and post-compensation. The compensating can be analog or digital.

Another aspect of the invention is a method for compensating for nonlinear impairment in multi-core fiber optic communication systems comprising taking into account distributed longitudinal variations of the chromatic dispersion in links including one or more multi-core fibers.

In this aspect of the invention, in one alternative, compensating is implemented as a correction to span-wise constant compensation of nonlinear impairment in one or more spans in the transmission line. In another alternative, compensating is implemented by taking into account longitudinal dispersion fluctuations on a subset of spans of a link. In one alternative, longitudinal variations of chromatic dispersions are implemented as piecewise constant functions along one or more spans of the transmission line. In yet another alternative, the dispersion profile in one or more spans is obtained with the inclusion of a type of interpolation selected from the group consisting of polynomial interpolation, spline interpolation, and another type of interpolation of a spatially-coarse dispersion profile. In still another alternative, smoothing of a spatially varying profile is employed.

The method described above can employ pre-compensation, post-compensation, or a combination of pre-compensation and post-compensation. The compensating can be analog or digital.

Another aspect of the present invention is a system for nonlinearity compensation employing pre-compensation comprising:

(1) a frequency-referenced bank of optical carriers;

(2) a first demultiplexer to which output from the frequency-referenced bank of optical carriers of (1) is conveyed;

(3) a multiplicity of transmitters to which output from the demultiplexer of (2) is conveyed;

(4) a nonlinearity compensation (NLC) computation engine;

(5) a transmission line comprising: (i) spans of optical fiber and (ii) optical amplifiers having first and second ends with the second end being a receiving end;

(6) a second demultiplexer to demultiplex WDM channels from the transmission line; and

(7) a plurality of receivers to detect signals produced by the second demultiplexer;

wherein the inverse of nonlinear interaction for particular data patterns to be transmitted over respective wavelength-division multiplexing (WDM) channels is computed in the NLC computation engine;
wherein the computed pre-compensating waveforms are imprinted onto the reference carriers in the respective transmitters;
wherein the computed pre-compensating waveforms are subsequently multiplexed by a WDM multiplexer and launched into the transmission line; and
wherein, at the receiving end, the WDM channels are de-multiplexed and are detected by the respective receivers.

In this system, the frequency-referenced bank of optical carriers can be derived from a frequency comb.

Yet another aspect of the present invention is a system for nonlinearity compensation employing post-compensation comprising:

(1) a set of transmitters;

(2) a plurality of WDM channels onto which information is imprinted by the set of transmitters of (1);

(3) a WDM multiplexer to multiplex the information from the plurality of WDM channels;

(4) a transmission line comprising: (i) spans of optical fiber and (ii) optical amplifiers having first and second ends with the second end being a receiving end;

(5) a first demultiplexer to demultiplex the WDM channels from the transmission line;

(6) a plurality of receivers to detect the demultiplexed WDM channels; wherein the receivers utilize a set of frequency referenced carriers as their local oscillators;

(7) a second demultiplexer to separate output from the local oscillators of (6); and

(8) a computational engine to perform nonlinearity mitigation based on received waveforms from the frequency referenced receiver bank.

In this system, the frequency-referenced bank of optical carriers can be derived from a frequency comb.

### Advantages of the Invention

The present invention provides improved systems and methods for compensation for nonlinear impairment in fiber optic links. These improved systems and methods improve the accuracy of fiber optic transmission and can also provide improved carrying capacity in fiber optic transmission, as well as extending the linear reach of the transmission.

Systems and methods according to the present invention possess industrial applicability for improving fiber optic transmission.

Methods according to the present invention result in physical changes in media and transmission of optical information.

The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein.

It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled.

What is claimed is:

1. A method for compensating for nonlinear impairment in single mode fiber optic communication systems comprising applying distributed, longitudinal variation of chromatic dispersion parameters having a longitudinal resolution smaller than the shortest span length in the link to compensate for nonlinear impairment.

2. The method of claim 1 wherein longitudinal variations of chromatic dispersions are implemented as piecewise constant functions along one or more spans of the transmission line.

3. The method of claim 1 wherein the dispersion profile in one or more spans is obtained by interpolation of a spatially coarse dispersion profile.

4. The method of claim 1 wherein a smoothed spatially varying profile is employed.

5. The method of claim 1 wherein the method for compensating is implemented as a correction to span-wise constant compensation of nonlinear impairment in one or more spans in a transmission line operating by single mode fiber optic communication.

6. The method of claim 1 wherein the method for compensating takes into account longitudinal dispersion fluctuations on a subset of spans of a link.

7. The method of claim 1 wherein the method employs pre-compensation.

8. The method of claim 1 wherein the method employs post-compensation.

9. The method of claim 1 wherein the method employs a combination of pre-compensation and post-compensation.

10. The method of claim 1 wherein the compensating is analog.

11. The method of claim 1 wherein the compensating is digital.

12. A method for compensating for nonlinear impairment in multi-core fiber optic communication systems comprising taking into account distributed longitudinal variations of the chromatic dispersion in links including one or more multi-core fibers.

13. The method of claim 12 wherein longitudinal variations of chromatic dispersions are implemented as piecewise constant functions along one or more spans of the transmission line.

14. The method of claim 12 wherein the dispersion profile in one or more spans is obtained with the inclusion of a type of interpolation selected from the group consisting of polynomial interpolation, spline interpolation, and another type of interpolation of a spatially-coarse dispersion profile.

15. The method of claim 12 wherein smoothing of a spatially varying profile is employed.

16. The method of claim 12 wherein compensating is implemented as a correction to span-wise constant compensation of nonlinear impairment in one or more spans in the transmission line.

17. The method of claim 12 wherein compensating is implemented by taking into account longitudinal dispersion fluctuations on a subset of spans of a link.

18. The method of claim 12 wherein the method employs pre-compensation.

19. The method of claim 12 wherein the method employs post-compensation.

20. The method of claim 12 wherein the method employs a combination of pre-compensation and post-compensation.

21. The method of claim 12 wherein the compensating is analog.

22. The method of claim 12 wherein the compensating is digital.

23. A system for nonlinearity compensation employing pre-compensation comprising:
(a) a frequency-referenced bank of optical carriers;
(b) a first demultiplexer to which output from the frequency-referenced bank of optical carriers of (a) is conveyed;
(c) a multiplicity of transmitters to which output from the demultiplexer of (b) is conveyed;
(d) a nonlinearity compensation (NLC) computation engine;
(e) a transmission line comprising: (i) spans of optical fiber and (ii) optical amplifiers having first and second ends with the second end being a receiving end;
(f) a second demultiplexer to demultiplex WDM channels from the transmission line; and
(g) a plurality of receivers to detect signals produced by the second demultiplexer;
wherein the inverse of nonlinear interaction for particular data patterns to be transmitted over respective wavelength-division multiplexing (WDM) channels is computed in the NLC computation engine;
wherein the computed pre-compensating waveforms are imprinted onto the reference carriers in the respective transmitters;
wherein the computed pre-compensating waveforms are subsequently multiplexed by a WDM multiplexer and launched into the transmission line; and
wherein, at the receiving end, the WDM channels are de-multiplexed and are detected by the respective receivers.

24. The system of claim 23 wherein the frequency-referenced bank of optical carriers is derived from a frequency comb.

25. A system for nonlinearity compensation employing post-compensation comprising:
(a) a set of transmitters;
(b) a plurality of WDM channels onto which information is imprinted by the set of transmitters of (a);
(c) a WDM multiplexer to multiplex the information from the plurality of WDM channels;
(d) a transmission line comprising: (i) spans of optical fiber and (ii) optical amplifiers having first and second ends with the second end being a receiving end;
(e) a first demultiplexer to demultiplex the WDM channels from the transmission line;
(f) a plurality of receivers to detect the demultiplexed WDM channels;
wherein the receivers utilize a set of frequency referenced carriers as their local oscillators;
(g) a second demultiplexer to separate output from the local oscillators of (f); and
(h) a computational engine to perform nonlinearity mitigation based on received waveforms from the frequency referenced receiver bank.

26. The system of claim 25 wherein the set of frequency referenced carriers as local oscillators are drawn from a frequency comb.
